(19) United States
(12) Patent Application Publication
(10) Pub. No.: US 2007/0012670 A1
(43) Pub. Date: Jan. 18, 2007

(54) Welding device and welding torch

(76) Inventor: Johann Otto Rudolph Stuut, Delfzjil (NL)

Correspondence Address: YOUNG & THOMPSON, 745 SOUTH 23RD STREET, 2ND FLOOR, ARLINGTON, VA, 22202, US

(21) Appl. No.: 10/569,501

(22) PCT Filed: Jul. 30, 2004
(86) PCT No.: PCT/NL04/00544

§ 371 Date: May 25, 2006

(30) Foreign Application Priority Data
Aug. 27, 2003 (NL) 1024169

(51) Int. Cl. B23K 9/12

(52) U.S. Cl. 219/125.1

(57) ABSTRACT

A welding device includes a welding station with a welding torch which is connected thereto and from which there extends a welding electrode with a free end. The welding electrode is electrically connected to a suitable electric welding power supply. After a fixation device provided for this purpose is released, the welding electrode is axially movable in the welding torch, so that the electrode can be adjusted in accordance with use. The welding electrode is accessible at an end remote from the free end to a drive member which is intended for and able to enter into co-action with the welding electrode in order to drive the welding electrode out of the welding torch.

The present invention relates to a welding device comprising a welding station with a welding torch which is connected thereto and from which there extends a welding electrode with a free end which, at least during operation, is electrically connected to an electric welding power supply and which, at least after fixation means provided for this purpose are released, is received for axial movement in the welding torch.

Welding has become an indispensable technique for connecting particularly metal parts to each other by fusion. A much-used form thereof is so-called fusion welding, wherein parts are mutually connected by fusing the material in the vicinity of the weld seam without any pressure at all being exerted. An important fusion welding method is so-called arc welding, wherein an electric arc is used to fuse the edges of the weld seam together with optionally added material, which may come for instance from the welding electrode. In the latter case this is referred to as arc welding with a consumable metal electrode. In arc welding a distinction can be made between open arc welding, arc welding under a protective atmosphere and covered arc welding under a powder cover. In arc welding under a protective atmosphere reactions with the outside air are prevented by surrounding the molten pool with an inert shielding gas, in particular a noble gas such as helium or argon. In addition to all types of iron and steel, rapidly oxidizing metals such as magnesium and aluminium can also be welded under such a noble gas shield. Known forms of these welding methods are TIG (tungsten inert gas) welding, wherein a non-consumable tungsten electrode is usually applied, and MIG (metal inert gas) welding, wherein a consumable metal electrode is normally used. The supplied gas (mixture) is used here solely with a view to the above stated protection of the workpiece against oxidation. In so-called MAG (metal active gas) welding the supplied gas plays a more active part in that it also contributes to the conversion of energy around the weld seam.

Welding is still frequently carried out as manual work and herein requires a high degree of skill in order to achieve a high welding quality. Particularly the reproducibility of the obtained welding result is of great importance here. With a view to cost-reduction and process control, however, recourse is increasingly being made where possible to more automated forms of welding. Robotized welding in particular has here become very common, especially in the automobile and aircraft industry, and has spread to other branches of industry. Because a welding robot can be fully programmed and can position the welding torch relative to the workpiece with a high degree of precision, a very high welding quality can thus be achieved with an equally high degree of reproducibility which is unrealistic in manual welding. A problem does however occur in welding techniques where use is made of a consumable welding electrode. Because this electrode becomes shorter during use, the distance from the tip of the electrode to the workpiece gradually becomes longer when positioning relative to the workpiece is the same, which has immediate consequences for the arc and the welding result. For this reason many robotized welding techniques are limited to the use of a non-consumable welding electrode, with the result that some metals can thus not be welded, or complicated calibration techniques are applied therein which greatly increase the cost price.

The present invention has for its object, among others, to provide a welding device and welding torch of the type stated in the preamble, with which the length of the welding electrode can be adjusted relatively easily and automatically, so that this length can also be held constant in the case of a consumable electrode.

In order to achieve the intended object, a welding device of the type stated in the preamble has the feature according to the invention that the welding electrode is accessible at an opposite end to a drive member which is intended for and able to enter into co-action with the welding electrode in order to drive the welding electrode out of the welding torch. Because the welding electrode is herein accessible to the drive member, which can be operated on command or automatically, the welding electrode can if necessary be continuously adjusted during operation. Particularly a decrease in the length of the welding electrode, as is inevitable in a welding process on the basis of a consumable welding electrode, can thus be compensated, whereby the welding process can proceed in fully automatic manner, even when such a consumable welding electrode is used.

The welding torch can in principle be embodied in different ways, taking into account the desired accessibility of the welding electrode to the drive member. In a particular embodiment however, the welding device according to the invention has the feature that the welding torch comprises an outer casing with an opening which provides access to a cavity into which the welding electrode protrudes with the opposite end, and that the cavity and opening are adapted to receive the drive member therein on a side remote from the welding electrode. The location and size of the opening are herein geared to the position of the welding electrode and the size of the drive member, so that a satisfactory mutual alignment can thus be obtained.

A further embodiment of the welding device has the feature according to the invention that the fixation means comprise a clamping sleeve which engages round the welding electrode and is directly accessible from outside. In order to enable a fully automatic adjustment thereof, the welding device has the feature in a further embodiment according to the invention that the clamping sleeve is provided with a forced control. The fixation of the welding electrode in the welding torch can thus be released or applied fully automatically by operating the forced control. A particular embodiment of the welding device according to the invention has in this respect the feature that the control comprises a gear rack on an outer end of a drive rod which engages on a toothing arranged externally on the clamping sleeve. The drive rod herein extends for instance from a controllable pressure cylinder, the stroke of which is adjusted to the desired degree of unlocking and locking of the welding electrode in the clamping sleeve.

In a preferred embodiment the welding device according to the invention is characterized in that the welding torch is provided with a resetting device which is able and intended to place the welding electrode at a fixed distance outside the torch. A fixed length of the welding electrode outside the torch can be maintained relatively easily by the resetting device, which is particularly important in the use of a consumable welding electrode. Ipso facto the distance from the outer end of the welding torch to the workpiece is hereby controllable, which makes a not inconsiderable contribution toward a sound welding result.

In respect of the resetting device, use can be made of electronic sensors, for instance optical sensors or pressure sensors, in order to determine the length of the welding electrode outside the welding torch. A relatively simple but no less effective embodiment thereof is applied in a further particular embodiment of the welding device according to the invention with the feature that the resetting device comprises a yoke which is connected movably to the frame and provided with a stop which can be moved at the fixed distance under the torch. During operation the stop and the welding torch are positioned relative to each other to then drive the welding electrode out of the welding torch onto the stop. After the fixation means have once again been applied and the stop removed, the welding torch is thus ready for use again with the desired length of the free outer end of the welding electrode.

A further particular embodiment of the welding device has the feature according to the invention that the welding torch can be manipulated from a base station to a workpiece and that the base station comprises the drive member and the resetting device. By here accommodating the drive member and the resetting device in the base station, the welding torch can remain relatively compact so as not to adversely affect access to positions on the workpiece which are more difficult to reach.

A further particular embodiment of the welding device has the feature according to the invention that the welding torch is arranged in stationary manner in a frame which also comprises the drive member and the resetting device. The frame herein provides for an efficient relative alignment of the welding torch with the welding electrode on the one hand and the drive member and the resetting device on the other.

In order to also allow processing of rapidly oxidizing metals, such as for instance aluminium and magnesium, a further particular embodiment of the welding device according to the invention has the feature that the welding torch is provided with supply means for supplying a protective shielding gas around a free outer end of the welding electrode. During operation the workpiece will thus be surrounded at the position of the weld seam by a protective atmosphere of the shielding gas, for instance a noble gas such as helium or argon or carbon dioxide, and the ambient air at this position will be displaced. Owing to the oxygen-free, or at least low-oxygen environment which is thus applied, oxidation on the surface of the weld seam can be efficiently prevented. A further particular embodiment of the welding device according to the invention has in this respect the feature that the welding electrode comprises a consumable metal stick, in particular a consumable tungsten stick, with which an aluminium workpiece can thus be welded in satisfactory manner.

The invention also relates to a welding torch as applied in the above specified welding device according to the invention, and will now be further elucidated on the basis of an exemplary embodiment and an accompanying drawing. In the drawing:

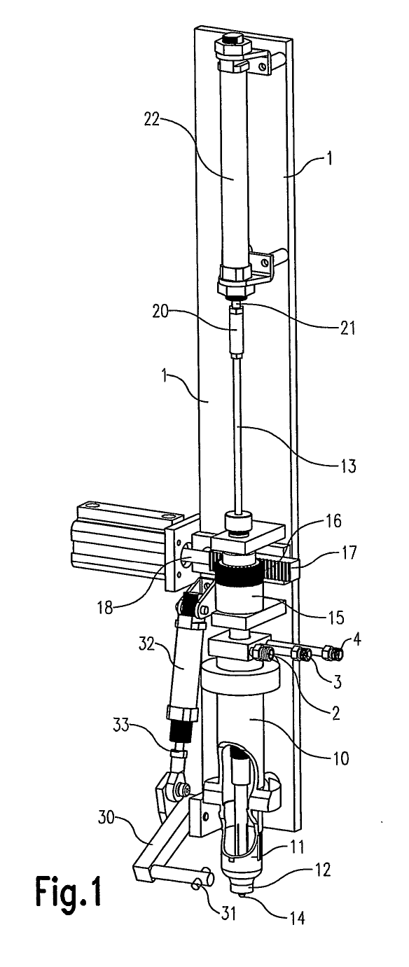

FIG. 1 shows a perspective view of a welding torch of an exemplary embodiment of a welding device according to the invention.

The welding device of FIG. 1 comprises a stationary welding torch 10 which is accommodated in a frame 1 and in addition a conventional welding station, assumed to be sufficiently well known to a skilled person and therefore not further shown, in which an electrical welding power supply for the welding torch and a gas cylinder or other container with a protective shielding gas are housed. Two electrical connecting cables extend from the welding station. A first of these is fixedly connected to an electrical connection of welding torch 10, while a second bears a mass clamp and is clamped therewith at a suitable, electrically conducting location to the workpiece. In order to protect the workpiece against oxidation at the position of the weld seam, a continuous flow of a suitable, inert shielding gas can be conducted over the workpiece during operation. Applied here as the shielding gas is a noble gas such as argon or helium, but other non-reactive or less reactive gases such as carbon dioxide are also suitable for this purpose. The gas is supplied from the container provided for this purpose in the welding station via a conduit connected to a connection 2 of the welding torch provided for this purpose. The shielding gas flows via this connection 2 and a hollow casing 11 of the welding torch to an open outer end 12 where a free end 14 of a welding electrode 12 extends outside casing 11. The free, active end 14 of welding electrode 13 is thus continuously surrounded by shielding gas during operation, so that ambient air is displaced at this location. Welding torch 10 further comprises an inlet and outlet 3,4 for coolant conduits, so that the operating temperature of the torch can be maintained at an acceptable level during operation.

In this embodiment use is made of a consumable tungsten electrode for welding electrode 13 in order to hereby enable welding of an aluminium workpiece under a protective atmosphere of the noble gas applied. Welding electrode 13 is received for axial movement in torch 10, but is fixed therein during operation by means of fixation means provided for the purpose. The fixation means here comprise a clamping sleeve 15 which is directly accessible from outside and which engages round and fixedly clamps the welding electrode 13. Electrode 13 can be released and locked by rotating clamping sleeve 15 counter-clockwise and clockwise respectively. In this embodiment use is made of a fully forced adjustment. For this purpose clamping sleeve 15 externally comprises a toothing 16 in which a gear rack 17 engages which is arranged on an end of a piston rod 18 of a pressure cylinder (not further shown). By extending the pressure cylinder the clamping sleeve 15 will rotate clockwise and thus clamp the electrode 13 fixedly in the torch, while conversely, with operation of the pressure cylinder in the opposite direction, the clamping sleeve 15 is loosened and the electrode 13 in the torch is released.

The longer the welding torch is used, the shorter the consumable welding electrode 13 will become, whereby the arc has to bridge a greater distance to the workpiece. This latter will eventually work to the detriment of a desired welding result. In order to avoid this, the welding torch is equipped with an automatic electrode adjustment. According to the invention the welding electrode 13 is accessible for this purpose to a drive member 20 on a side remote from the free end 14. Drive member 20 comprises a stop on an outer end of a piston rod 21 of a pressure cylinder 22 which is mounted together with torch 10 in frame 1. By successively releasing clamping sleeve 15 and extending pressure cylinder 22 the welding electrode 13 will be driven out of the torch and once again assume the desired length outside torch 10, whereafter the clamping sleeve can be tightened again.

So as to ensure that electrode 13 is always driven to the same, fixed length outside torch 10, the welding torch is provided with a resetting device. The resetting device here comprises a yoke 30 connected movably, i.e. pivotally, to frame 1. On its outer end the yoke 30 comprises a stop 31 for receiving the free end 14 of the welding electrode thereon. Yoke 30 is controlled fully automatically with a pressure cylinder 32 coupled thereto. By extending a piston rod 33 hereof, the yoke 30 pivots about its pivot axis in the frame and the stop moves to a fixed distance under the frame. The welding electrode is then driven out of torch 10 in the above stated manner until electrode 13 strikes with the free end 14 bumps against stop 31. The welding electrode now once again has the desired length outside torch 10 and can be fixed in the welding torch again, whereafter the stop is removed by retracting pressure cylinder 33. The welding torch is then ready for a subsequent operating cycle.

The above described adjustment of the welding electrode in the torch thus proceeds fully automatically and can be carried out as often as is necessary to maintain the desired welding result.

Although the invention has been further elucidated above with reference to only a single exemplary embodiment, it will be apparent that the invention is by no means limited thereto. On the contrary, many other variations and embodiments are possible ed within the scope of the invention for a person with ordinary skill in the art. Instead of a calibrated setting making use of a resetting device in any form, use can thus also be made of a continuous adjustment of the welding electrode which takes into account a normal burn-off rate. Nor is the invention only suitable for a welding torch in stationary arrangement, but it is also suitable for a mobile welding torch. An automatic adjustment of the welding electrode can herein be integrated into the welding torch, but is advantageously disposed outside of it in order to keep the welding torch as compact as possible. In this case use is preferably made of a welding torch which can be manipulated using a separate base station in which the drive member and optionally a resetting device are accommodated.

The invention is also suitable for a wide range of welding processes, varying in accordance with the material of the electrode and the optionally used shielding gas. These welding processes are not limited here to those based on a consumable electrode, but can also make use of non-consumable electrodes. In addition to aluminium and other rapidly oxidizing metals such as for instance magnesium, normal metals can also be welded using the device according to the invention. The invention thus provides a very widely applicable device with which a welding process can be carried out fully automatically.

1-12. (canceled)

13. A welding device comprising:
a welding station with a welding torch which is connected thereto and from which there extends a welding electrode with a free end which, at least during operation, is electrically connected to an electric welding power supply and which, at least after fixation means provided for this purpose are released, is received for axial movement in the welding torch, wherein
the welding electrode is accessible at an opposite end to a drive member which is intended for and able to enter into co-action with the welding electrode, and the drive member is provided with means to drive the welding electrode automatically out of the welding torch.

14. The welding device as claimed in claim 13, wherein the fixation means comprise a clamping sleeve which engages round the welding electrode and is directly accessible from outside, and that the clamping sleeve is provided with a forced control.

15. The welding device as claimed in claim 14, wherein the control comprises a gear rack on an outer end of a drive rod which engages on a toothing arranged externally on the clamping sleeve.

16. The welding device as claimed in claim 13, wherein the welding torch is provided with a resetting device which is able and intended to place the welding electrode at a fixed distance outside the torch.

17. The welding device as claimed in claim 16, wherein the resetting device comprises a yoke which is connected movably to the frame and provided with a stop which can be moved at the fixed distance under the torch.

18. The welding device as claimed in claim 16, wherein the welding torch can be manipulated from a base station to a workpiece and that the base station comprises the drive member and the resetting device.

19. The welding device as claimed in claim 16, wherein the welding torch is arranged in stationary manner in a frame which also comprises the drive member and the resetting device.

20. The welding device as claimed in claim 13, wherein the welding torch is provided with supply means for supplying a protective shielding gas around a free outer end of the welding electrode.

21. The welding device as claimed in claim 20, wherein the welding electrode comprises a consumable metal stick.

22. The welding device as claimed in claim 21, wherein the metal stick is a tungsten stick.
